(19) United States
(12) Patent Application Publication
(10) Pub. No.: US 2005/0158141 A1
(43) Pub. Date: Jul. 21, 2005

(54) Self-piercing nut

(76) Inventor: Tadashi Shinjo, Osaka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/030,977

(22) Filed: Jan. 10, 2005

(30) Foreign Application Priority Data
Jan. 19, 2004 (JP) JP2004-010463

(51) Int. Cl. F16B 37/04

(52) U.S. Cl. 411/180

(57) ABSTRACT

A self-piercing nut has a pilot portion (13) integral with a nut body (11) and around a central threaded bore (12), the pilot portion has an end face for punching a hole in a metal panel (30). A periphery (14) of nut body and the pilot portion (13) define between them an annular groove (15), and a circular edge (31,32) around the hole is pressed into this groove to firmly attach the nut to the panel. The periphery has slanted and upright wall sections (16,18), and an inner surface (17) of each slanted section forms an inflated cavity, with each upright section's inner surface (19) in parallel with the nut axis. Each slanted section (16) has radial shoulders (20) continuing to upright sections (18) and protruding into the groove (15) from a plane including the upright sections.

### FIELD OF THE INVENTION

The present invention relates to a self-piercing nut that comprises a nut body for punching a hole through a metal panel in such a manner that a generally circular edge of the hole is caulked to bite and fix the nut in position.

### PRIOR ART

Self-piercing nuts of this type are known in the art (see for example the Japanese Patent No. 2816645). Each of them has a pilot portion formed around a central threaded bore of a nut body, and this portion protruding therefrom has an end face for punching a hole in a metal panel. A periphery of the nut body has a downward protrusion (in the drawings) surrounding the pilot portion so as to define between them an annular groove. The end face of said pilot portion is projected (downwards) a distance from a bottom face of the periphery of nut body. In use, the pilot portion will pierce the metal panel so that a circular edge of the hole thus formed is simultaneously caulked into the annular groove, thereby firmly attaching the nut to the panel.

FIGS. 9 and 10 illustrate the self-piercing nut of the prior art type, in which its nut body 1 has a central threaded bore 2 and a pilot portion 3 surrounding this bore. The pilot portion 3 is surrounded by a periphery 4 of the nut body so that an annular groove 5 is defined between these portion and periphery. An end face 3a of pilot portion 3 is projected a distance from a bottom face 4a of the periphery 4, and this periphery is slanted inwards all around the center of nut body 1. Tapered upwards and outwards relative to the axis of nut is an inner circular wall 6 of said periphery 4, and arranged at angular intervals are protuberances 7 that are formed in the bottom of annular groove 5. As seen in FIG. 11, as the pilot portion 3 is struck into a desired area of a metal panel 8, a hole consequently formed therein will have a circular edge 9 to be plastically forced into the groove 5. The slanted inner circular wall 6 of periphery 4 will serve to grip in a caulking manner the circular edge 9. On the other hand and at the same time, such a pressed circular edge will bite the bottom of said groove in between the adjacent protuberances 7. The nut body 1 firmly fixed on the metal panel 8 in this manner will show a desired clinch force (against pulling-off) in addition to a torque resistance (against idle rotations).

However, plastic deformation of each circular edge 9 pressed into the annular groove 5 has noticeably reduced thickness ‘e’ of the bent region of this edge. Such a thinned region of circular edge 9 has often produced cracks therein in the course of time. A fatigue breakage of the nut body's 1 portion attached to the panel 8 has sometimes been caused until the former would slip off the latter as shown in FIG. 12.

### SUMMARY OF THE INVENTION

An object of the present invention made in view of the drawbacks in the prior art is therefore to provide a novel self-piecing nut that will not cause any cracks to the circular edge of a hole formed in a metal panel to be attached to the nut in a caulking manner. This self-piercing nut has to enable stronger fixation of the nut body and ensure a higher clinch force (against pulling-off) as well as higher torque resistance (against idle rotations).

In order to achieve this object, a self-piercing nut proposed herein may comprise a pilot portion formed on and integral with a nut body and around a central threaded bore thereof, and this portion protruding from the nut body has an end face for punching a hole in a metal panel. A periphery of the nut body has a downward protrusion (in the drawings) surrounding the pilot portion so as to define between them an annular groove. The end face of said pilot portion is projected (downwards) a distance from a bottom face of the periphery of nut body. In use, the pilot portion will pierce the metal panel so that a circular. edge around the hole thus formed is simultaneously caulked into the annular groove, thereby firmly attaching the nut to the panel. Characteristically, the protrusion of the nut body's periphery is composed of a plurality of slanted wall sections and a plurality of upright wall sections such that they alternate with each other. An inner surface of each slanted wall section is inclined relative to a nut axis so as to form a cavity gradually inflated inwardly away from the bottom face. An inner surface of each upright wall section extends in parallel with the nut axis, and each slanted wall section has radial shoulders extending along its opposite sides that continue to the adjacent upright wall sections. Each radial shoulder protrudes inwardly into the annular groove towards the nut axis from a circular plane including the upright wall sections.

By virtue of these features, the nut body will be adjoined to a metal panel in a unique manner. Although the bent regions of one portions of circular edge defining the hole are thinned to bear against the inner surfaces of slanted wall sections, the other bent regions of the other portions of circular edge will scarcely be thinned to bear against the inner surfaces of upright wall sections. This will effectively reduce the likelihood of producing any noticeable number of cracks in or near the circular edge of a hole punched in the metal panel. The one portions of circular edge are not only pressed into a tight contact with the inner surfaces of slanted wall sections, but also the radial shoulders of each slanted wall section will strongly bite adjacent portions of the circular edge. Thus, the nut body adjoined to a metal panel will show a higher clinch force (against pulling-off) as well as higher torque resistance (against idle rotations).

An annular bottom, that is a ceiling in the drawings, of the annular groove may be composed of sunken zones and raised zones alternating one with another at angular intervals. In this case, the circular edge portions around the hole formed in a metal panel will be forced into a close contact with the sunken zones. Thus, torque resistance (against idle rotations) of the self-piecing nut attached to the panel will be enhanced. It is preferable to arrange the sunken zones adjacent to the slanted wall sections, with the raised zones arranged adjacent to the upright wall sections.

The clinch force (against pulling-off) may be enhanced by tapering the pilot portion relative to the nut axis such that the outer periphery of this portion decreases its diameter inwardly from the end face towards a top of the nut.

Further, the pilot portion may be profiled in cross section so as to enhance the torque resistance (against idle rotations).

The nut body of the present self-piercing nut may not necessarily have a round periphery, but have a polygonal periphery such as of a square shape, a hexagonal shape or the like.

The essence and all the embodiments of the invention summarized above are effective to achieve the objects as set forth above.

### BRIEF DESCRIPTION OF THE DRAWINGS

FIG. 1 is a plan view of a self-piercing nut provided in an embodiment of the present invention;

FIG. 2 is a cross section taken along the line 2-2 in FIG. 1;

FIG. 3 is a vertical cross section of the self-piercing nut attached to a metal panel;

FIG. 4 is a vertical cross section of the self-piercing nut provided in another embodiment;

FIG. 5 is a plan view (vertical cross section) of the self-piercing nut provided in still another embodiment;

FIG. 6(a) is a vertical cross section (scheme) of the self-piercing nut provided in a further embodiment, whose raw slanted wall sections have just been prepared by the pressing method;

FIG. 6(b) is likewise a vertical cross section (scheme) of the self-piercing nut of FIG. 6(a), whose slanted wall sections have just been finished by a succeeding compression process;

FIG. 7 is a plan view of the self-piercing nut provided in a still further embodiment;

FIG. 8 is a cross section taken along the line 8-8 in FIG. 7;

FIG. 9 is a plan view of the prior art self-piercing nut;

FIG. 10 is a cross section taken along the line 10-10 in FIG. 9;

FIG. 11 is a vertical cross section of the prior art self-piercing nut attached to a metal panel; and

FIG. 12 is likewise a vertical cross section of the prior art self-piercing nut unintentionally detached from the metal panel.

### THE PREFERRED EMBODIMENTS

Now some embodiments of the present invention will be described referring to the accompanying drawings.

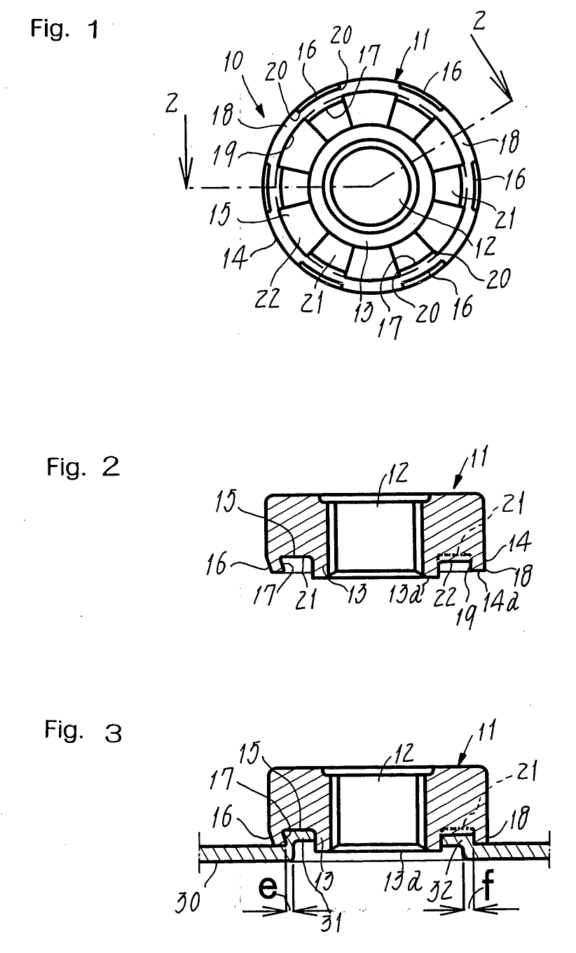

FIGS. 1 and 2 show a self-piercing nut 10 provided herein and comprising similarly to the prior art ones a pilot portion 13 formed around a central threaded bore 12 of a nut body 11 and protruding therefrom. The cylindrical pilot portion 13 has an end face for punching a hole in a metal panel. A round periphery 14 of the nut body 11 has a downward axial protrusion (in the drawings) surrounding the pilot portion 13 so as to define between them an annular groove 15. Also similarly to the prior art round type self-piercing nuts, the end face 13a of said pilot portion 13 is projected downwards a distance from a bottom face 14a of the periphery 14 of nut body. However, contrary to the prior art, the present nut does not have the axial protrusion of periphery 14 uniformly slanted inwards towards the axis of nut, all around it.

As will be seen well in FIG. 1, the protrusion of round periphery 14 of the present nut is composed of a plurality of slanted wall sections 16 and a plurality of upright wall sections 18 alternating with the former ones 16. Inner surfaces 17 of the slanted sections 16 are inclined relative to a nut axis so that a distance between each surface and the axis does increase inwardly and upwards in the drawings. Inner surfaces 19 of the upright wall sections 18 extend in parallel with the nut axis. For easy manufacture, all the wall sections of periphery 14 may be prepared at first as upright ones 18 so that every second one of them is subsequently tilted inwards. As a result, each slanted wall section 16 has radial shoulders 20 and 20 extending along opposite sides of the inner surface 17 of this section that continue to the inner surfaces 19 of adjacent upright wall sections 18. Each of the radial shoulders 20 protrudes inwardly towards the nut axis from a circular plane including the upright wall sections 18. As will be discussed later in detail, these radial shoulders 20 will bite a metal panel 30 to which the self-piercing nut 10 is struck and attached, thereby affording a high torque resistance (against idle rotations) thereof.

In order to enhance further the torque resistance of this nut 10 attached to the panel 30, an annular bottom (or ceiling in FIG. 1) of the annular groove 15 may be composed of deeper or sunken zones 21 and shallower or raised zones 22. These deeper and shallower zones 21 and 22 alternate with each other as shown in FIG. 1, and the former ones 21 continue from the respective slanted wall sections 16, with the latter ones 22 from the upright sections 18. In another or contrary example, the deeper zones 21 may continue from the upright sections 18, with the shallower ones 22 continuing from the slanted sections 16. In any case, curved regions 31 of a circular edge surrounding a hole which the pilot portion 12 of nut body 11 punches in a metal panel 30 will be forced into a close contact with such deeper zones 21 of annular bottom, providing a higher torque resistance.

As shown at ‘e’ in FIG. 3, one bent regions of the portions 31 of circular edge defining the hole in a metal 30 that is being adjoined to the nut 10 are thinned to bear against the inner surfaces 17 of slanted wall sections 16. Other bent regions of the portions 32 of said circular edge will maintain almost fully its original or intrinsic thickness ‘f’ scarcely thinned to bear against the inner surfaces 19 of upright wall sections 18. This will effectively reduce the likelihood of producing any noticeable number of cracks in or near the circular edge around a hole punched in the metal panel 30. On the other hand, the one portions of circular edge 31 are pressed into a tight contact with inner surfaces 17 of slanted wall sections 16. The radial shoulders 20 and 20 present along the opposite sides of either inner surfaces 17 will also strongly bite adjacent portions of the circular edge in the panel 30. Thus, the self-piercing nut 10 adjoined to this panel will show a higher clinch force (against pulling-off) as well as higher torque resistance (against idle rotations).

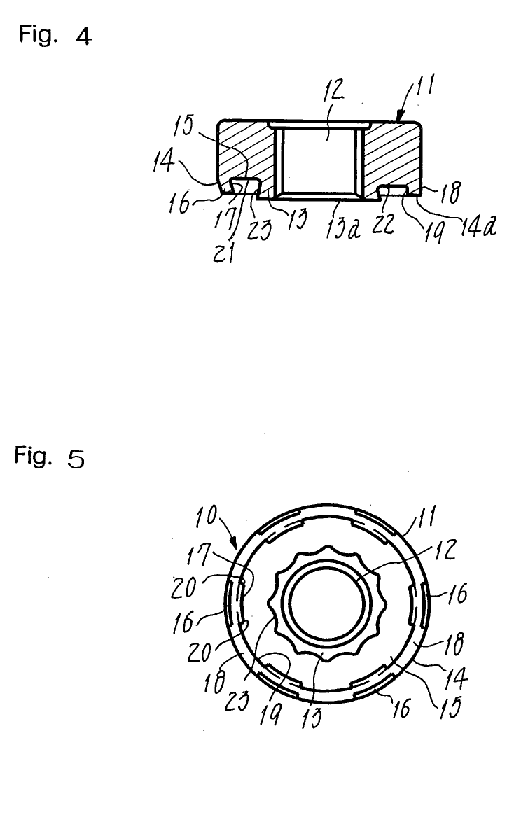

The clinch force (against pulling-off) may be enhanced by tapering the pilot portion, as shown in FIG. 4. In this case, the pilot portion 13 is tapered relative to the nut axis such that the outer periphery 23 of this portion decreases its diameter inwardly from the end face 13a towards a top of the nut. Both the portions 31 and 32 of the circular edge around the hole in the metal panel 30 will be forced to a close engagement with the outer periphery's 23 surface reducing its diameter towards the top of this nut. The clinch force (against pulling-off) thus enhanced will contribute to a stronger and surer attachment of the nut 10 to the metal panel 30.

As shown in FIG. 5, the pilot portion 13 may have its periphery 23 not round but profiled in cross section so as to enhance the torque resistance (against idle rotations) of the self-piercing nut 10 relative to the metal panel 30.

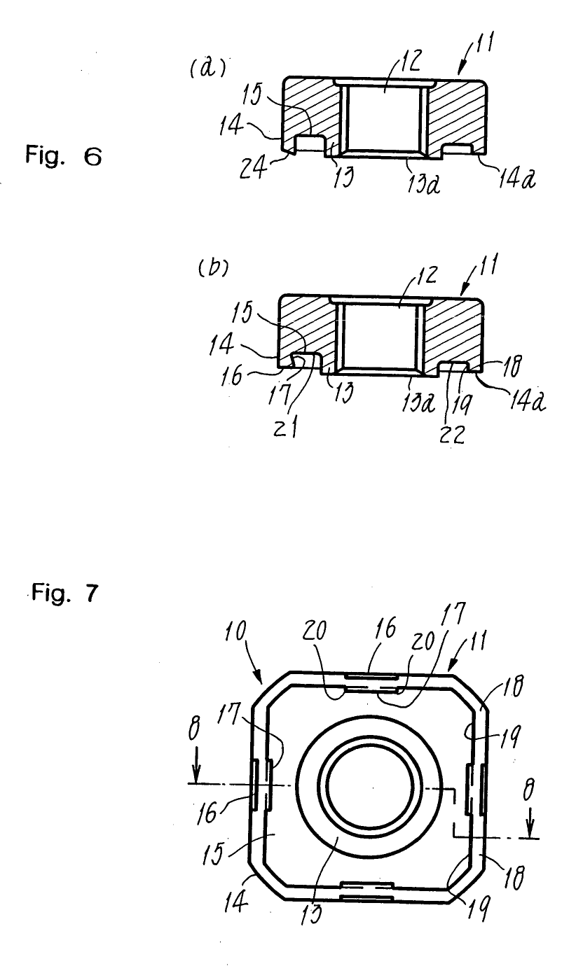

FIGS. 6(a) and 6(b) show a modified manufacture process for forming the slanted wall sections 16 to be integral with the periphery 14 of nut body 11. As in the preceding cases, the pilot portion 13 as well as the periphery 14 and annular groove 15 may simultaneously be formed by pressing a metal blank of the nut body 11. However in this example shown in FIG. 6(a), an acute extremity 24 will be produced to depend from a peripheral wall portion 14 where one of the slanted section 16 is to be shaped. Next, the upright periphery 14 will be compressed vertically in such a manner that it remains upright but each acute extremity 24 is flattened to give a modified slanted wall section 16 with an inner surface 17 as shown in FIG. 6(b). The bottom face of such wall sections 16 will provide a larger seat enabling the self-piercing nut 10 to be more surely fixed on a metal panel 30.

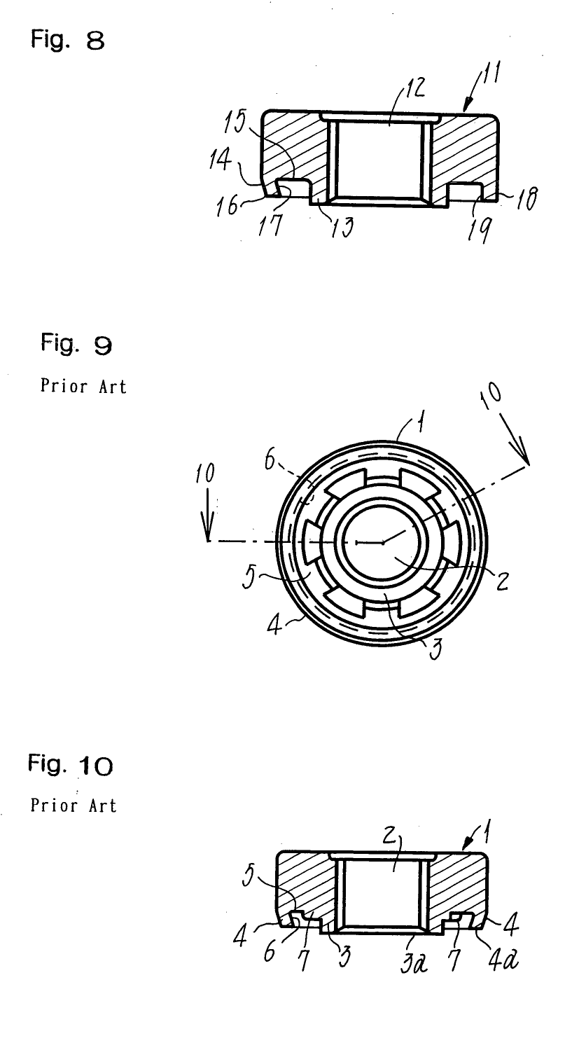

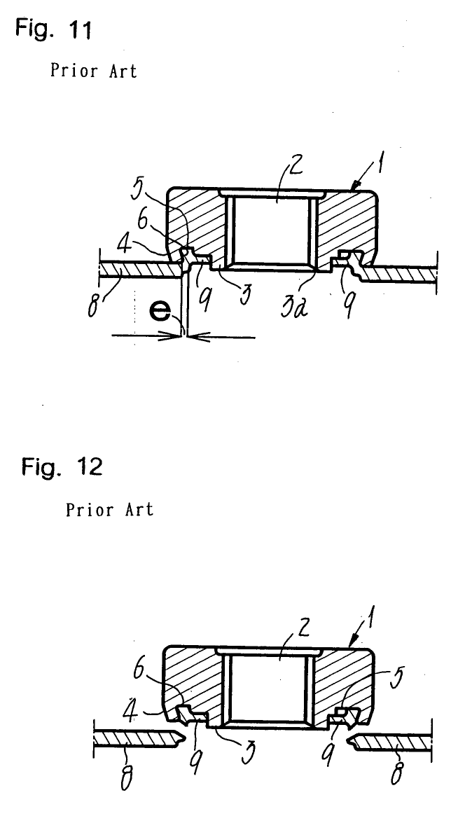

Although the self-piercing nuts 10 in the foregoing examples have round peripheries 14, the invention may apply also to any polygonal nut such as square and hexagonal ones. FIGS. 7 and 8 show an example of square nut 10 that does not need any deeper zones 21 or shallower zones 22 in its bottom of annular groove 15.

1. A self-piercing nut comprising:
a nut body having a central threaded bore,
a pilot portion formed on and integral with the nut body and around the threaded bore thereof,
the pilot portion having an end face for punching a hole in a metal panel,
the nut body having a periphery with a protrusion surrounding the pilot portion so as to define between them an annular groove,
the end face of said pilot portion being projected a distance from a bottom face of the periphery of nut body, so that the pilot portion will pierce the metal panel in such a manner that a circular edge around the hole thus formed is simultaneously caulked into the annular groove, thus firmly attaching the nut to the panel,
wherein the protrusion of the nut body's periphery is composed of a plurality of slanted wall sections and a plurality of upright wall sections such that they alternate with each other, such that an inner surface of each slanted wall section is inclined relative to a nut axis so as to form a cavity gradually inflated inwardly away from the bottom face, and an inner surface of each upright wall section extends in parallel with the nut axis, and
wherein each slanted wall section has radial shoulders extending along its opposite sides that continue to the adjacent upright wall sections, and each radial shoulder protrudes into the annular groove towards the nut axis from a circular plane including the upright wall sections.

2. A self-piercing nut as defined in claim 1, wherein an annular alternating one with another at angular intervals.

3. A self-piercing nut as defined in claim 2, wherein the sunken zones are arranged adjacent to the slanted wall sections, with the raised zones arranged adjacent to the upright wall sections.

4. A self-piercing nut as defined in claim 1, wherein the pilot portion is tapered relative to the nut axis such that an outer periphery of this portion decreases its diameter inwardly from the end face towards a top of the nut.

5. A self-piercing nut as defined in claim 1, wherein the pilot portion is profiled in cross section.

6. A self-piercing nut as defined in claim 4, wherein the pilot portion is profiled in cross section.

7. A self-piercing nut as defined in claim 1, wherein the nut body has a round periphery.

8. A self-piercing nut as defined in claim 4, wherein the nut body has a round periphery.

9. A self-piercing nut as defined in claim 5, wherein the nut body has a round periphery.

10. A self-piercing nut as defined in claim 6, wherein the nut body has a round periphery.

11. A self-piercing nut as defined in claim 1, wherein the nut body has a polygonal periphery.

12. A self-piercing nut as defined in claim 4, wherein the nut body has a polygonal periphery.

13. A self-piercing nut as defined in claim 5, wherein the nut body has a polygonal periphery.

14. A self-piercing nut as defined in claim 6, wherein the nut body has a polygonal periphery.
